(19) United States
(12) Patent Application Publication
(10) Pub. No.: US 2020/0298303 A1
(43) Pub. Date: Sep. 24, 2020

(54) Method of manufacturing continuous cast aluminium alloy strip of variable width

(71) Applicant: Aleris Rolled Products Germany GmbH, Koblenz (DE)

(72) Inventors: Philippe MEYER, Koblenz (DE); Florian LANDGRAF, Jüchen (DE)

(73) Assignee: Aleris Rolled Products Germany GmbH, Koblenz (DE)

(21) Appl. No.: 16/084,051

(22) PCT Filed: Mar. 16, 2017
(86) PCT No.: PCT/EP2017/056233

§ 371 Date: Sep. 11, 2018

(30) Foreign Application Priority Data
Mar. 18, 2016 (EP) 16161156.1

(51) Int. Cl. B22D 11/00; B23K 20/12; B23K 26/08; B21C 47/02; C22F 1/04; C21D 8/02

(52) U.S. Cl. CPC B22D 11/003; B23K 20/122; B23K 26/0846; B21C 47/02; B23K 2103/10; C21D 8/0226; C21D 8/0231; C21D 8/0236; C21D 8/0273; C22F 1/04

(57) ABSTRACT

A method of manufacturing an aluminium alloy strip article of variable width by means of continuously casting an aluminium alloy strip article, typically in a gauge range of 3 mm to 40 mm, and including the steps of,
providing a first continuously cast aluminium alloy strip article at intermediate gauge and at least a second continuously cast aluminium alloy strip article at intermediate gauge, each of the aluminium alloy strip articles to be welded have the same thickness and are of the same aluminium alloy;
welding the first aluminium alloy strip article at intermediate gauge to the second aluminium alloy strip article at intermediate gauge to form a welded aluminium alloy strip article; and
rolling in at least one further rolling step of the welded strip article to a final gauge.

### FIELD OF THE INVENTION

The present invention relates to a method of manufacturing an aluminium alloy strip article of variable width by means of continuously casting an aluminium alloy strip article, hot or warm rolling of the continuously cast strip article, and optionally cold rolling of the hot or warm rolled strip article, to final gauge.

### BACKGROUND OF THE INVENTION

Metal strip articles (such as metal strip, slab and plate), particularly those made of aluminium and aluminium alloys, are commonly produced in continuous strip casting apparatus. In such apparatus, molten aluminium alloy is introduced between two closely spaced (usually actively cooled) elongated moving casting surfaces forming a narrow casting cavity. The aluminium alloy is confined within the casting cavity until the aluminium alloy solidifies (at least sufficiently to form an outer solid shell), and the solidified strip article is continuously ejected from the casting cavity by the moving casting surfaces and may be produced in indefinite length, and thereafter the cast article is commonly subjected to a hot rolling operation, and optionally also to a cold rolling operation, to obtain its final gauge. And depending of the specific aluminium alloy also at least an annealing heat treatment after the rolling operation(s) and possibly one or more intermediate annealing heat treatments might be required. One form of such continuous strip casting apparatus is a twin-belt caster in which two confronting belts are circulated continuously and molten aluminium alloy is introduced by means of a launder or injector into a thin casting cavity formed between the confronting regions of the belts. An alternative is a rotating block caster in which the casting surfaces are formed by blocks that rotate around a fixed path and join together adjacent the casting cavity to form a continuous surface. The aluminium alloy is conveyed by the moving belts or blocks for a distance effective to solidify the aluminium alloy, and then the solidified strip emerges from between the belts at the opposite end of the apparatus.

In order to confine the molten and semi-solid aluminium alloy within the casting cavity, i.e. to prevent the aluminium alloy escaping laterally from between the casting surfaces, it is usual to provide metal side dams at each side of the apparatus and determining together with the nozzle width or the injector width of the continuous caster the width of the continuous cast strip article. For twin-belt and rotating block casters, side dams of this kind can be formed by a series of metal blocks joined together to form a continuous chain aligned in the casting direction at each side of the casting cavity. These blocks, normally referred to as side dam blocks, are trapped between and move along with the casting surfaces and are recirculated so that blocks emerging from the mould exit move around a guided circuit and are fed back into the entrance of the mould. The blocks are guided on this circuit by means of a metal track, or the like, on which the blocks can slide in a loose fashion that allows for limited movement between the blocks, especially as they move around curved parts of the circuit.

When casting strip articles in this way, it is often desirable to produce strip articles of different lateral widths for different purposes. When using the conventional arrangement, this involves terminating the casting operation after the completion of casting of a product of a first width, and re-configuring the caster for the production of a strip article of a second width. For example, it may be necessary to replace one metal injector for a different one of different width, and to move the side dam blocks correspondingly towards or away from the centre line of the casting surfaces (which involves moving the entire circuit for recirculating the side dam blocks through the casting cavity and around the external circuit). This is cumbersome and time-consuming.

There are systems or arrangements for facilitating the change-over of the casting equipment when aluminium alloy strip articles of different widths are to be produced. Such a continuous casting apparatus is for example known from patent document EP-2411171 (Novelis) and from EP-2411172 (Novelis). Although these known apparatuses create some flexibility regarding the width of the aluminium alloy strip article, the width variation is still limited to the physical dimensions of the continuous casting apparatus. In addition, with an increasing width of the metal strip article during the continuous casting operation it becomes more difficult to reach the required flatness across the metal strip article and also it becomes much more difficult to control the thickness tolerances across the width.

It is therefore an object of the present invention to provide a method for manufacturing a continuously cast aluminium alloy strip article having an increased flexibility of its width.

### DESCRIPTION OF THE INVENTION

As will be appreciated herein below, except as otherwise indicated, aluminium alloy designations and temper designations refer to the Aluminium Association designations in Aluminium Standards and Data and the Registration Records, as published by the Aluminium Association in 2015 and well known to the persons skilled in the art. The temper designations are laid down in European standard EN515.

For any description of alloy compositions or preferred alloy compositions, all references to percentages are by weight percent unless otherwise indicated.

As used herein, the term “about” when used to describe a compositional range or amount of an alloying addition means that the actual amount of the alloying addition may vary from the nominal intended amount due to factors such as standard processing variations as understood by those skilled in the art.

This and other objects and further advantages are met or exceeded by the present invention providing a method of manufacturing an aluminium alloy strip article of variable width by means of continuously casting an aluminium alloy strip article, typically in a gauge range of 3 mm to 40 mm, and comprising the steps of:

a. providing a continuously cast first aluminium alloy strip article at non-final or intermediate gauge and at least a second continuously cast aluminium alloy strip article at non-final or intermediate gauge;

b. and welding the first continuously cast aluminium alloy strip article at non-final gauge to the second continuously cast aluminium alloy strip article at non-final or intermediate gauge to form a flat welded aluminium alloy strip article and thereby increasing the width of the whole strip article, and wherein each of the aluminium alloy strip articles to be welded have the same thickness and are of about the same aluminium alloy; and

c. rolling in one or more further rolling step of the welded aluminium alloy strip article to a final gauge. The rolling direction is in the length direction of the strip article along the weld joint. Depending on the condition aluminium alloy strips prior to the welding step and on the required final gauge of the welded strip article the one or more further rolling steps can be hot or warm rolling only, or cold rolling only, or a combination of hot or warm rolling followed by cold rolling.

In accordance with the invention it has been found that the method enables the manufacturing of wide aluminium alloy strip articles with increased flexibility with regard to its width. The wider strip articles meet the demand for wider sheet aluminium products for forming complex parts by means of deep-drawing and stamping. The increased flexibility is without capital investment for a wider continuous caster apparatus. The method avoids practical issues on thickness tolerance and fluctuations on sheet flatness commonly associated when continuously casting wider sheet products. The increased width of the welded strip articles can be targeted for manufacturing formed parts such that added parts, viz. the second and optional third strip article, are used to facilitate the material flow in a subsequent forming or shaping operation such that it can be avoided that any possible material imperfections resulting from the welding operation does not need to end up in the final formed part of pre-determined shape, but instead may remain in the cutting area or in the draw bead area of said formed part, e.g. using a stamping or deep-drawing operation, made from the welded strip article obtained by the method according to this invention. No visual imperfections have to be present in the final formed or shaped part while it benefits from the improved material flow in a forming or shaping operation due to the increased width of the welded strip article. The welding operation to form a welded strip article followed by at least one further rolling operation enables a recrystallization of the microstructure in the welded zone and/or a more homogeneous microstructure throughout the weld.

In an embodiment of the present invention, the at least two aluminium alloy strip articles are adjacent. By “adjacent” it is meant herein that the at least two aluminium alloy strip articles have edges or sides in abutment with each other such that a butt weld is achieved.

In an embodiment of the invention the welding is done either by means of laser beam welding (LBVV) or by friction stir welding (FSW).

In a preferred embodiment the welding is done by means of FSW and avoids the use of filler wire that might adversely alter the local chemistry in the welded zone in the welded aluminium alloy strip article. FSW can be carried out on thick gauge materials and can be employed in a continuous fashion. Furthermore, FSW in combination with at least one further rolling operation of the welded aluminium alloy strip article may enhance the mechanical properties of the welded zone. FSW was developed and patented in the early 1990s by The Welding Institute in the UK and has been used in assembling aluminium alloys. A key principle of friction stir welding is that it is a solid-state welding technique by applying strong shear to the metal using a rotating tool that stirs the two materials to be assembled. First, the yield stress is reduced by heating the metal by applying friction using a shoulder portion of the rotating tool to the metal surface, and the tool is then moved to make the weld by gradually moving it in a forward direction. The shoulder portion of the tool also contains the metal and maintains the pressure to avoid metal ejection outside the welded zone. FSW is capable of avoiding hot cracking, which in particular means that aluminium alloys articles that may have previously been considered as very difficult or even not being weldable by fusion, can now be welded.

In an embodiment the welded aluminium alloy strip article receives a post-weld surface treatment of at least the welded zone prior to further rolling of the welded strip to thinner gauge. The post-weld surface treatment is by mechanical re-working the welded zone area to smoothen the surface, for example by means of grinding, milling, end mill cutting, but is not limited thereto. In an embodiment the post-weld surface treatment includes a scalper drawn directly after the welding tool to obtain an in-line surface smoothening treatment. In case of FSW being applied for the welding step the scalper would at least cut any flow-arm. The subsequent rolling operation(s) further smoothen the weld surface area.

Pursuant to the invention the first continuously cast aluminium alloy strip article and the at least a second continuously cast aluminium alloy strip article, both articles at non-final or intermediate gauge and at non-final temper, are welded to each other to form a welded aluminium alloy strip article. In an embodiment, however, also a third continuously cast aluminium alloy strip article at non-final or intermediate gauge can be welded to the first continuously cast aluminium alloy strip article. Such a third strip article is preferably welded to the opposite side of said first strip article and thereby providing a wider welded aluminium alloy strip article having the first strip article in the centre and having on one side the second and on the other side the third strip article welded thereto.

In an embodiment each of the first, second, and third aluminium alloy strip articles at intermediate gauge to be welded to each other are in the same as-cast condition.

In an embodiment each of the first, second, and optional third aluminium alloy strip articles at intermediate gauge to be welded to each other are in the same hot-rolled condition. This can be in an intermediate hot-rolled condition and preferably at a gauge of up to 10 mm such that after the welding step the welded aluminium alloy strip article is, after reheating to hot or warm rolling temperature, further hot or warm rolled, optionally followed by further cold rolling. Alternatively each of the aluminium alloy strip articles to be welded have been hot rolled to a hot-mill end gauge, typically up to 10 mm, and preferably in a gauge range of 1 mm to 5 mm, such that after the welding step the welded aluminium alloy strip article is only cold rolled in one or more rolling steps to its final gauge in the range of 0.25 mm to 4.0 mm.

When cold rolling in one or multiple steps is being applied the total thickness reduction by the cold rolling operation is at least 30%, preferably at least 40%, and more preferably at least 50%.

It is preferred that each of the first, second, and third aluminium alloy strip articles to be welded to each other have the same thickness at the start of the welding step.

It is preferred that each of the first, second, and third aluminium alloy strip articles to be welded to each other are made of the same aluminium alloy.

Both non-heat-treatable and heat-treatable alloys can be processed via the method according to the invention, and in particular the aluminium alloy is selected from the group consisting of 2xxx, 3xxx, 5xxx, 6xxx, 7xxx, and 8xxx series aluminium alloys.

In particular the 3xxx (e.g. 3004, 3103, 3104, 3105), 5xxx (e.g. 5052, 5102, 5182, 5083, 5754), and 6xxx (e.g. 6111, 6014, 6016, 6022) series aluminium alloys can be used for automotive sheet applications, in particular for forming (e.g. by means of stamping or deep-drawing) into shaped articles like inner panels, heat shields, and as transportation trailer sheet.

Also the 7xxx-series aluminium alloys (e.g. 7020, 7021, 7075, 7081, 7085) can be used for an automotive sheet applications, in particular for use in closure panels (e.g. hoods, fenders, doors, roofs, and trunk lids, among others), wheels, tunnels, bulkheads, footwells, and critical strength applications, such as body-in-white (e.g., A-, B-, and Cpillars, reinforcements) applications, and automotive crashworthy or other energy-absorbing applications amongst others.

The 3xxx-series aluminium alloys in the form of sheet products can be used also in the building and construction industry.

In an embodiment the first aluminium alloy strip article has a width (W1) larger than the width (W2) of the second aluminium alloy strip article and of the width (W3) of the optional third aluminium alloy strip article. The first aluminium alloy strip article has typically a width (W1) in a range of about 1000 mm to about 2400 mm. A more preferred upper-limit for W1 is about 1800 mm. The width (W2,W3) of respectively the second and the optional third aluminium alloy strip article is typically each in a range of about 100 mm to about 700 mm, and more preferably up to about 500 mm. This would allow for the production of significantly wider sheet material than can be manufactured from monolithic sheet material continuously cast on most industrial continuous casters, whereas any potentially undesired feature of the welded area can be kept in the cutting area of the shaped product of predetermined shape when formed in a subsequent forming operation such as by means of deep-drawing, pressing or stamping.

In an embodiment of the method the welded strip article after the welding step is being coiled prior to being rolled to its final gauge. The coiling facilitates the storage of feedstock for the rolling operation, hot rolling or cold rolling or both, to its final gauge.

It is preferred that at final gauge the rolled welded strip article is at a gauge in a range of 0.25 mm to 4 mm.

The rolled welded strip article at final gauge is then either annealed followed by suitable cooling and optional coiling to produce 0 temper products, or solution heat treated, followed by suitable quenching and optional ageing to produce T temper products, depending on the aluminium alloy used and the temper desired. The temperature of the heating step and the subsequent quenching step will vary depending on the desired temper.

As used herein, the term “anneal” refers to a heating process that preferably causes recrystallization of the metal to occur, producing uniform formability and assisting in earing control. Typical temperatures used in annealing aluminium alloys range from about 315° to 480° C.

Also as used herein, the term “solution heat treatment” refers to a metallurgical process in which the metal is held at a high temperature so as to cause the second phase particles of the alloying elements to dissolve into solid solution. Temperatures used in solution heat treatment are generally higher than those used in annealing, and range up to about 570° C. This condition is then maintained by quenching of the metal for the purpose of strengthening the final product by subsequent controlled precipitation (ageing).

Following annealing/solution heat treatment additional steps include passing the welded strip article through a tension leveler to flatten the sheet, and subjecting it to surface inspection. The resulting aluminium alloy sheet product is then coiled at a coiling station for stocking and shipment, and thereafter can be uncoiled and subsequently cut-to-length or blanked for use in for example a forming or stamping operation to produce a shaped article of pre-determined shape.

### DESCRIPTION OF THE DRAWINGS

The invention shall also be described with reference to the appended drawings, in which:

FIG. 1 shows schematically the strip article before and after welding process used in the method.

FIG. 2 shows a flow chart illustrating one embodiment of the process for producing a continuously cast strip article having a variable width.

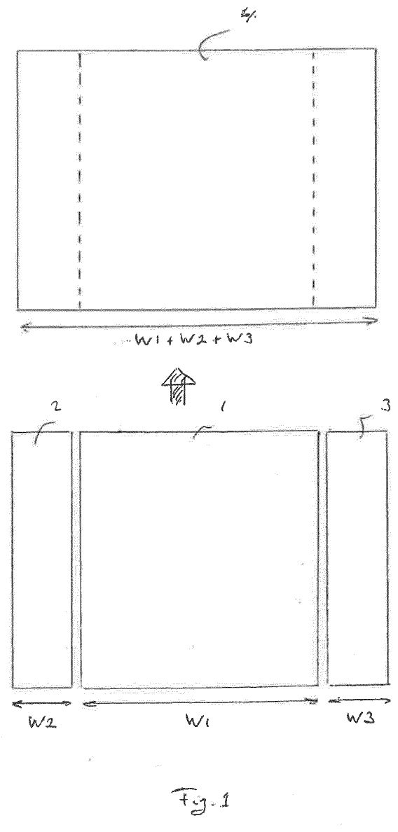

In FIG. 1 a first, second and third aluminium alloy strip articles (1,2,3) at intermediate gauge and having respectively a width W1, W2, and W3 are welded together (not shown) to form a single welded strip (4) having a total width of the sum of W1+W2+W3. For example W1 can be selected at about 1200 mm and W2 and W3 each at about 200 mm such that the welded strip width (4) is about 1700 mm and which can be subsequently rolled to final gauge. The rolling direction is in the length direction of the strip article along the weld joint.

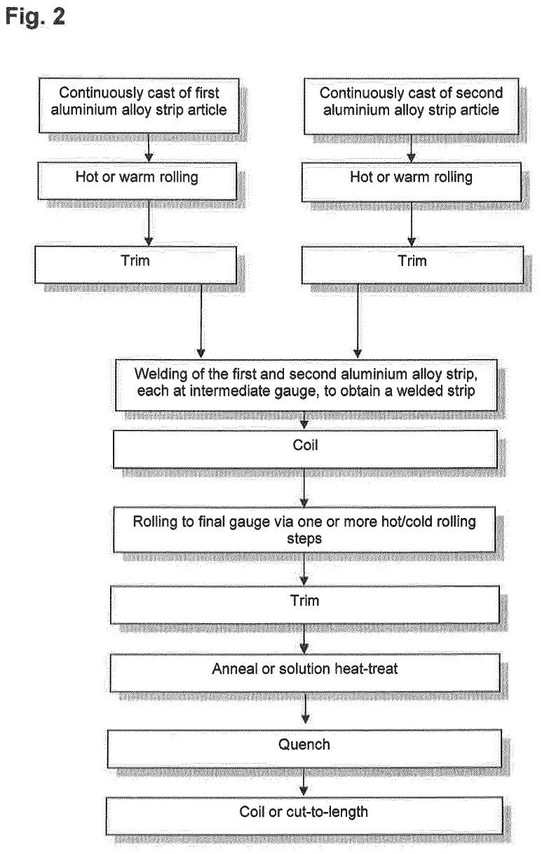

In the embodiment illustrated in FIG. 2 a first and second aluminium alloy strip article of the thickness and the same aluminium alloy composition (and are thus similar and not dissimilar with respect to their alloy composition) are produced separately from each other via continuously casting and typically have a gauge in a range of 3 mm to 40 mm. Once the continuously cast strip articles are removed from the casting apparatus, the continuously cast strip articles may be hot or warm rolled, such as to hot-mill end gauge (typically in a range of up to 10 mm and preferably in a range of 1 mm to 5 mm) or hot-mill intermediate gauge and then edge trimmed to provide strip edges suitable for welding into a butt-weld. At this stage also each alloy strip article is cut into the desired width whereby the first aluminium alloy strip article is preferably wider than the second aluminium alloy strip article. Via a (continuous) welding operation, e.g. FSW, the first and second aluminium alloy strip articles are welded together to form a welded strip, preferably receiving a post-weld surface treatment (not shown), and then coiled. Thereafter the coiled welded strip material is being rolled to its final gauge (preferably in a range of 0.25 mm to 4.0 mm) via one or more hot and/cold rolling steps and if necessary again trimmed. The rolled welded strip article at final gauge is then either annealed followed by suitable quenching and optional coiling or cut-to-length to produce 0 temper products, or solution heat treated, followed by suitable quenching and optional coiling or cut-to-length to produce T temper products, depending on the aluminium alloy used and the temper desired.

The present invention also relates to the use or to a method of use of the aluminium alloy strip article at a final gauge in a range of 0.25 mm to 4.0 mm as obtained by the method as described herein for forming into automotive panels, more in particular for forming into inner panels or heat shields, or as transportation trailer sheet. Furthermore the strip articles can be used advantageously in the building and construction industry.

In the following, the invention will be explained further by the following non-limitative examples.

### Example 1

An article of the AA3105 alloy has been manufactured on an industrial scale via continuous casting. The article was in the as-cast condition and had a thickness of 22 mm. From this article two blocks of 600×150×22 mm were cut to provide two blocks or articles of similar alloy composition and thickness. The two blocks were bud-welded to each other via friction stir welding to widen the width of an article and to provide proof of principle of the present invention. The friction stir welding operation has been done using a 100 kN PTG Powerstir 345 FSW gantry machine, a welding tool of 20 mm has been used applying a rotational speed of 380 rpm, a penetration depth of 19.92 mm and a tilt angle of 3.5°, and a welding speed of 50 mm/min. After the welding operation any typical FSW flaw has been removed by milling to obtain a smooth surface. The welded aluminium strip article has been heated to about 440° C. and without any difficulty hot rolled to a thickness of 2 mm using a reduction of about 30% per rolling pass, and subsequently cold rolled in multiple rolling passes to a final gauge of 1 mm.

Some mechanical properties (yield strength or Rₚ₀₂, tensile strength or Rₘ, and the elongation A₅₀) of both the base material and the welded zone have been determined after hot rolling (HR) and after cold rolled (CR). The results are listed in Table 1. In Table 1 for the welded area the absolute numbers are listed as well as percentage of the base material.

TABLE 1
Mechanical properties of the welded article
both in the base material and in the welded
area during various phases of the production process.

| | Base material | | | Welded area | | | | | |
|---|---|---|---|---|---|---|---|---|---|
| | R_{p0.2} | Rₘ | A₅₀ | R_{p0.2} | Rₘ | A₅₀ | R_{p0.2} | Rₘ | A₅₀ |
| | [MPa] | [MPa] | [%] | [MPa] | [MPa] | [%] | [MPa] | [MPa] | [%] |
| | | | | | | | As percentage of the | | |
| | | | | | | | base material | | |
| HR | 220 | 248 | 3.2 | 215 | 240 | 5.7 | 98% | 97% | 177% |
| CR | 242 | 287 | 1.8 | 269 | 283 | 3.4 | 111% | 99% | 186% |

This example shows that the welded article can be successfully hot rolled and cold rolled to final gauge. From the results listed in Table 1 it can be seen that as expected the mechanical strength increases after the cold rolling operation, both for the base material and the welded area. Following the cold rolling operation the properties of the welded area are similar or exceed those of the base material. It is believed that the FSW operation may have created a favourable grain structure in the welded area and which is to some extent retained following further processing by means of rolling.

From this example it can be seen that the width of a continuous cast article can be increased by welding together, in this case by means of FSW, another article of similar composition and thickness. The welded article can be further processed by means rolling to final gauge such that the mechanical properties of the welded area are close to or exceed those of the base material. Such a welded article may be used in a subsequent forming or stamping operation to produce a shaped article of pre-determined shape. The width of the welded article can be varied dependent on requirements.

### Example 2

An article of the AA5182 alloy has been manufactured on an industrial scale via continuous casting to a thickness of 22 mm and hot rolled to an intermediate gauge of 3.4 mm. From this hot-rolled article two blocks of 600×3000×3.4 mm were cut and the two blocks were bud-welded to each other via laser beam welding to increase the width of an article. The welding has been done using a Trumpf TruDisk 16002 disk-laser with a fibre diameter of 300 μm, the collimation length was 200 mm with a focus length of 400 mm and a focus diameter of 0.6 mm. The joint length was 300 mm obtained at a speed of 3 m/min under Argon atmosphere.

The welded aluminium strip article has been solely cold rolled without any difficulty from 3.4 mm to 1.2 mm using multiple rolling passes and then annealed at 350° C.

Some mechanical properties (yield strength or R_{p0.2}, tensile strength or Rm, and elongation A₅₀) of both the base material and the welded zone have been determined in the as-welded condition (AW), in the cold rolled condition (CR) and in the annealed condition (AN). The results are listed in Table 2. In Table 2 for the welded area the absolute numbers are listed as well as percentage of the base material.

TABLE 2
Mechanical properties of the welded article
both in the base material and in the welded
area during various phases of the production process.

| | Base material | | | Welded area | | | | | |
|---|---|---|---|---|---|---|---|---|---|
| | R_{p0.2} | Rₘ | A₅₀ | R_{p0.2} | Rₘ | A₅₀ | R_{p0.2} | Rₘ | A₅₀ |
| | [MPa] | [MPa] | [%] | [MPa] | [MPa] | [%] | [MPa] | [MPa] | [%] |
| | | | | | | | As percentage of | | |
| | | | | | | | the base material | | |
| AW | 208 | 237 | 7.6 | 167 | 216 | 2.5 | 80% | 91% | 32% |
| CR | 351 | 401 | 5.5 | 345 | 382 | 3.1 | 98% | 98% | 57% |
| AN | 146 | 265 | 21.9 | 143 | 261 | 21.7 | 98% | 98% | 99% |

From the results of Table 2 it can be seen that in the as-welded condition the mechanical properties of the welded area are significantly lower than of the base material. However, the welded article can still be successfully cold rolled using a total cold rolling reduction of about 65%. Following the cold rolling operation the yield strength and the tensile strength of the welded area approach the properties of the base material, whereas the elongation is still falling short. However, after annealing the properties of the welded area are within measurement accuracy the same as those of the base material.

From this example it can be seen that the width of a continuous cast article can be increased by welding together, in this case by means of laser beam welding, another article of similar composition and thickness. The welded article can be further processed by means rolling to final gauge such that the mechanical properties of the welded area are close of those of the base material. Such a welded article may be used in a subsequent forming or stamping operation to produce a shaped article of pre-determined shape. The width of the welded article can be varied dependent on requirements or needs without a capital investment for a continuous caster having an increased nozzle width.

Where is Example 1 and Example 2 materials has been taken from one and the same continuously cast strip material, as set out with reference to FIG. 2 it will be evident for the skilled person that on a larger scale a first article is being continuously cast having a certain width limited by the nozzle width of the casting apparatus and that the width of said first article can be increased by welding a strip thereto of similar composition and thickness taken from a separately continuously cast second article and optionally a third article.

The invention is not limited to the embodiments described before, which may be varied widely within the scope of the invention as defined by the appending claims.

1. A method of manufacturing an aluminium alloy strip article of variable width by means of continuously casting an aluminium alloy strip article, and comprising the steps of,
providing a first continuously cast aluminium alloy strip article at intermediate gauge and at least a second continuously cast aluminium alloy strip article at intermediate gauge, wherein each of the aluminium alloy strip articles to be welded have the same thickness, and are of the same aluminium alloy; and
welding said first aluminium alloy strip article at intermediate gauge to said second aluminium alloy strip article at intermediate gauge to form a welded aluminium alloy strip article; and
rolling in at least one further rolling step of the welded strip article to a final gauge.

2. The method according to claim 1, wherein the welded strip article has been joined utilizing a butt-weld.

3. The method according to claim 1, wherein the welding to form the welded strip article is by friction stir welding or laser beam welding.

4. The method according to claim 1, wherein there is provided a third continuously cast aluminium alloy strip article at intermediate gauge welded to the first aluminium alloy strip article and having the same thickness and the same alloy composition as said first aluminium alloy strip article.

5. The method according to claim 1, wherein each of the aluminium alloy strip articles to be welded are in an as-cast condition.

6. The method according to claim 1, wherein each of the aluminium alloy strip articles to be welded are in a hot-rolled condition.

7. The method according to claim 6, wherein the aluminium alloy strip articles to be welded have a thickness in a range of up to 10 mm.

8. The method according to claim 1, wherein the aluminium alloy is selected from the group consisting of 2xxx, 3xxx, 5xxx, 6xxx, 7xxx, and 8xxx series aluminium alloys.

9. The method according to claim 1, wherein the aluminium alloy is a 3xxx-series aluminium alloy.

10. The method according to claim 1, wherein the aluminium alloy is a 5xxx-series aluminium alloy.

11. The method according to claim 1, wherein the aluminium alloy is a 6xxx-series aluminium alloy.

12. The method according to claim 1, wherein the first aluminium alloy strip article has a width in a range of 1000 mm to 2400 mm, and any further aluminium alloy strip article welded to said first aluminium alloy strip article has a width less than the width of the first aluminium alloy strip article.

13. The method according to claim 1, wherein the welded strip article after the welding step is coiled.

14. The method according to claim 1, wherein the welded strip article is rolled to its final gauge solely by hot rolling.

15. The method according to claim 1, wherein the welded strip article is rolled to its final gauge solely by cold rolling.

16. The method according to claim 1, wherein the welded strip article is rolled to its final gauge by hot rolling followed by cold rolling.

17. The method according to claim 1, wherein the welded strip article is rolled to a final gauge in the range of 0.25 mm to 4.0 mm.

18. The method according to claim 1, wherein the welded strip article after rolling to final gauge is being annealed or solution heat treated.

19. The method according to claim 1, wherein the aluminium alloy strip article is in the form of automotive sheet.

20. The method according to claim 1, wherein the aluminium alloy strip article is subsequently in a forming operation formed into an article of pre-determined shape.

21. A method of using of an aluminium alloy strip article obtained by the method according to claim 1, comprising forming the aluminium alloy strip article into an automotive panel in a forming operation.

22. The method according to claim 1, wherein the aluminium alloy strip article has a gauge range of 3 mm to 40 mm.

23. The method according to claim 6, wherein the aluminium alloy strip articles to be welded have a thickness in a range of 1 mm to 5 mm.

24. The method according to claim 1, wherein the first aluminium alloy strip article has a width in a range of 1000 mm to 1800 mm, and any further aluminium alloy strip article welded to said first aluminium alloy strip article has a width less than the width of the first aluminium alloy strip article.
